(19) United States
(12) Patent Application Publication
(10) Pub. No.: US 2005/0178446 A1
(43) Pub. Date: Aug. 18, 2005

(54) Valve mechanism of the bladders of an air packing bag

(75) Inventor: Tai-Hua Chen, Taipei (TW)

Correspondence Address: BACON & THOMAS, PLLC, 625 SLATERS LANE, FOURTH FLOOR, ALEXANDRIA, VA, 22314, US

(73) Assignee: Camry Packing Industrial Limited, Sindian City (TW)

(21) Appl. No.: 10/828,313

(22) Filed: Apr. 21, 2004

(30) Foreign Application Priority Data
Feb. 18, 2004 (TW) 093202284

(51) Int. Cl. F16K 15/14

(52) U.S. Cl. 137/512.15

(57) ABSTRACT

A valve mechanism mounted in the bladders of an air packing bag is disclosed. The valve mechanism includes an upper film, a lower film, and a plurality of spaced heat-proof members sandwiched therebetween. The spacing and the length of the heat-proof members correspond to the quantity of the bladders. The valve mechanism is extended in the mouth of each bladder. Further, pressure inside the inflated bladder pushes both the upper and the lower films to urge against an inner surface of the upper sheet for blocking air from leaving the bladder.

### BACKGROUND OF THE INVENTION

1. Field of the Invention

The present invention relates to air packing bags and, more particularly, to a valve mechanism of the bladders of the air packing bag with improved characteristics.

2. Description of Related Art

Valve mechanisms of the bladders of air packing bags are well known. For example, Taiwanese Patent Published No. 245,227 disclosed an air packing bag including a valve mechanism having an extended member for closing the valve mechanism. Further, Taiwanese Patent Published No. 363,600 disclosed an air packing bag including a valve mechanism having a zipper for closing the valve mechanism.

However, the extended member or zipper provided in either prior art is complex in construction. Moreover, it is known that a typical air packing bag has a plurality of bladders each having an independent valve mechanism. Hence, the construction is more complex and the manufacturing cost thus increases if the zipper or the extended member serves as the closing means of the valve mechanism.

Therefore, it is desirable to provide a novel valve mechanism of the bladders of an air packing bag in order to mitigate and/or obviate the aforementioned problems.

### SUMMARY OF THE INVENTION

An object of the present invention is to provide a valve mechanism mounted in a plurality of bladders of an air packing bag, comprising an upper film, a lower film, and a plurality of spaced heat-proof members sandwiched between the upper and lower films, wherein the spacing and the length of the heat-proof members correspond to the quantity of the bladders.

In one aspect of the present invention each of the upper and lower films has a thickness about 30 μm to 35 μm.

In another aspect of the present invention each of the upper and the lower films is formed of PE.

In still another aspect of the present invention the valve mechanism is disposed between an upper sheet and a lower sheet of the bag.

In yet another aspect of the present invention the valve mechanism is extended in the mouth of each bladder.

In a further aspect of the present invention pressure inside the inflated bladder pushes both the upper and the lower films to urge against an inner surface of the upper sheet to prevent air from escaping the bladder.

Other objects, advantages, and novel features of the invention will become more apparent from the following detailed description when taken in conjunction with the accompanying drawings.

### BRIEF DESCRIPTION OF THE DRAWINGS

FIG. 1 is a top plan view of a valve mechanism of the bladders of an air packing bag according to the present invention;

FIG. 2 is a sectional view taken along line A-A of FIG. 1;

FIG. 3 schematically depicts the forming of the valve mechanism in the air packing bag;

FIG. 4 is a top plan view of an air packing bag incorporating the valve mechanism;

FIG. 5 is a sectional view showing the bladder during inflating;

FIG. 6 is a view similar to FIG. 5, the bladder being inflated and the film-type valve mechanism being closed for blocking the air passage; and

FIG. 7 is a perspective view of the inflated bag.

### DETAILED DESCRIPTION OF THE PREFERRED EMBODIMENT

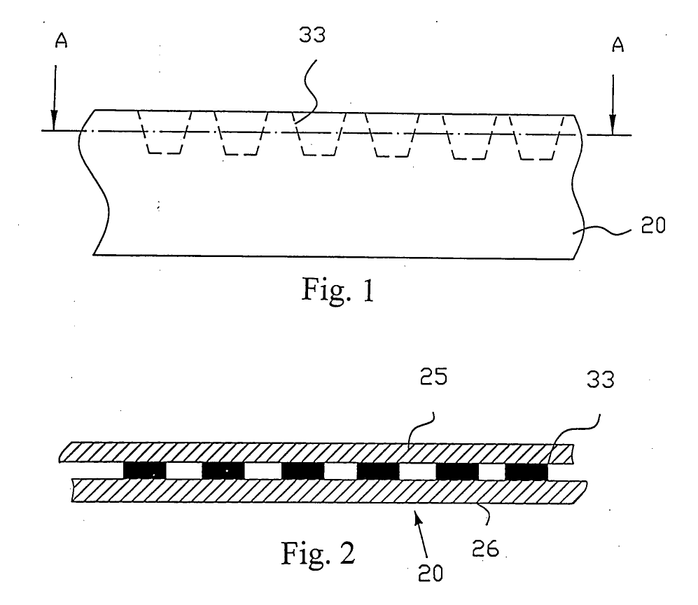

With reference to FIGS. 1 and 2, there is shown a valve mechanism 20 provided in the bladders of an air packing bag in accordance with the present invention. The valve mechanism 20 is formed of PE (polyethylene) and comprises an upper film 25, a lower film 26, and a plurality of heat-proof members 33 sandwiched between the upper and lower films 25, 26. The heat-proof members 33 are spaced apart and are disposed from one end of the valve mechanism 20. The spacing and the length of the heat-proof members 33 are designed to correspond to the quantity of the bladders of the bag. The provision of the heat-proof members 33 aims at preventing the upper and the lower films 25 and 26 from being adhered together during hot pressing. As an end, air inflation can be facilitated. The heat-proof member 33 serves as inlet of the bladder in an inflation process. Each of the upper and the lower films 25 and 26 has a thickness of about 30 μm to 35 μm. The formed valve mechanism 20 has a thickness of about 60 μm to 70 μm.

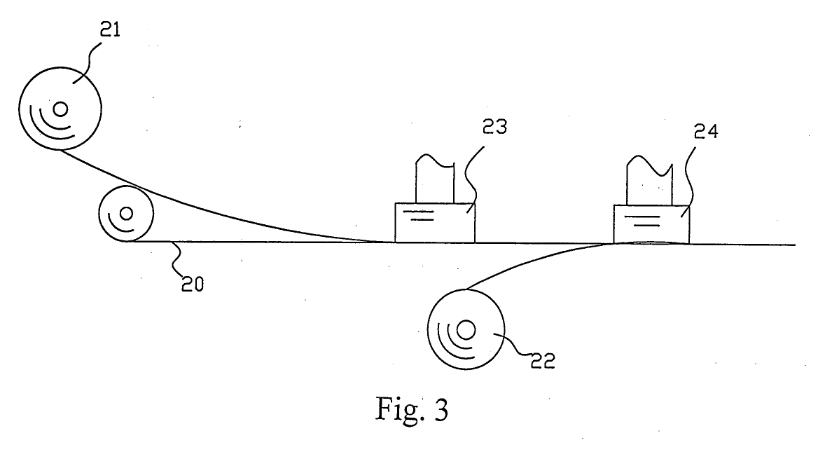

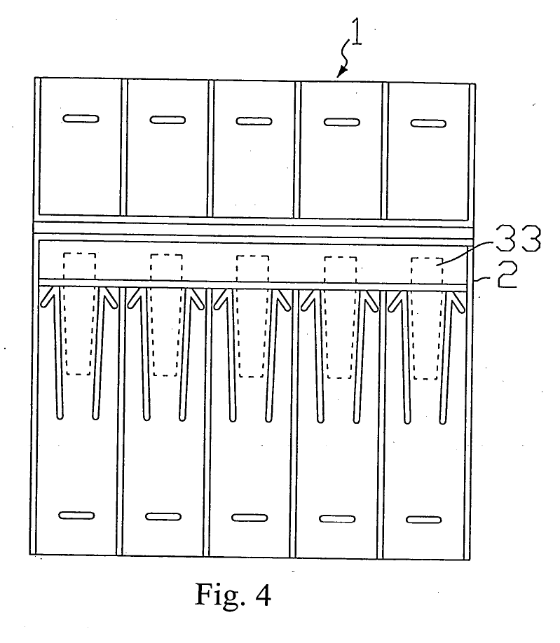

With reference to FIGS. 3 and 4, the formed valve mechanism 20 in the shape of a roll is drawn out of a roller prior to being pressed together with an upper sheet of plastic 21 by heating by a press 23. Next, it is conveyed to another press 24 so as to be pressed together with a lower sheet of plastic 22 by heating by the press 24. Next, it undergoes a plurality of processes including sealing, cooling, folding, and cutting prior to forming an air packing bag 1 (see FIG. 4). The valve mechanism 20 is formed between the upper and lower sheets 21 and 22.

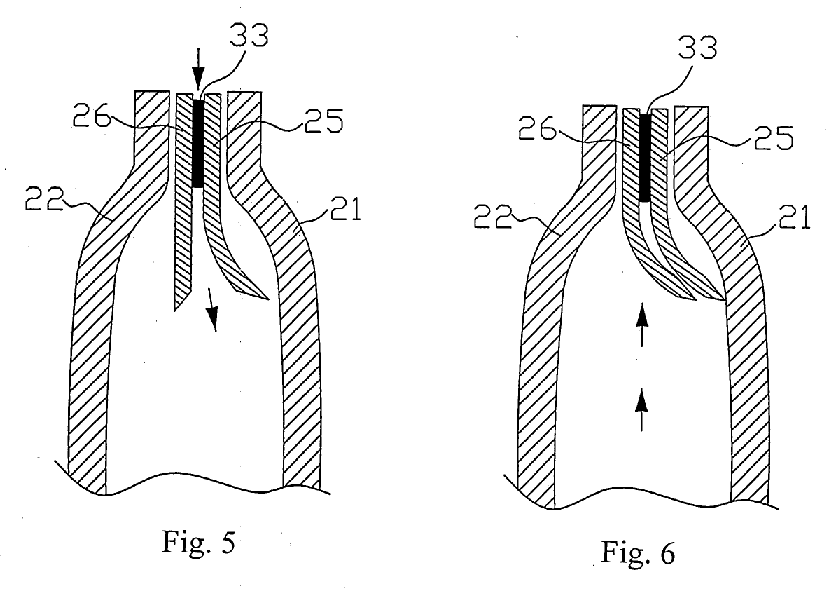

With reference to FIG. 5, the bladder is blown full as air enters by passing an air valve 2 and a gap (i.e., the heat-proof member 33) between the upper and the lower films 25 and 26. The upper and the lower films 25 and 26 are prevented from adhering together due to the provision of the heat-proof member 33 in the mouth of each bladder even after a series of hot pressing processes have been performed.

With reference to FIG. 6, high pressure inside the inflated bladder pushes both the upper and the lower films 25 and 26 to urge against an inner surface of the upper sheet 21 for blocking air from leaving the bladder.

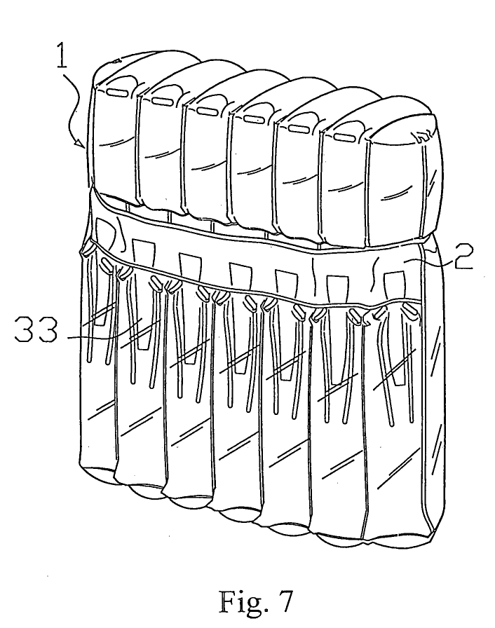

With reference to FIG. 7, there is shown an inflated bag 1 with all bladders being blown full. Goods can be placed in the bladders prior to shipping or storage.

In brief, the present invention provides the valve mechanism including the upper and the lower films and a plurality of heat-proof members sandwiched therebetween as inlets of the bladders. This can eliminate the provision of an air valve in each bladder. As an end, the manufacturing cost is greatly reduced and the production is increased.

Although the present invention has been explained in relation to its preferred embodiment, it is to be understood that many other possible modifications and variations can be made without departing from the scope of the invention as hereinafter claimed.

1. A valve mechanism mounted in a plurality of bladders of an air packing bag, comprising:
an upper film;
a lower film; and
a plurality of spaced heat-proof members sandwiched between the upper film and the lower film,
wherein the spacing and the length of the heat-proof members correspond to the quantity of the bladders.

2. The valve mechanism as claimed in claim 1, wherein the upper film has a thickness from 30 μm to 35 μm.

3. The valve mechanism as claimed in claim 1, wherein the lower film has a thickness from 30 μm to 35 μm.

4. The valve mechanism as claimed in claim 1, wherein the upper film and the lower film are formed of PE.

5. The valve mechanism as claimed in claim 1, wherein the valve mechanism is disposed between an upper sheet and a lower sheet of the air packing bag.

6. The valve mechanism as claimed in claim 1, wherein the valve mechanism is extended in a mouth of each bladder.

7. The valve mechanism as claimed in claim 1, wherein pressure inside the inflated bladder pushes both the upper film and the lower film to urge against an inner surface of the upper sheet for blocking air from leaving the bladder.
